(19) United States
(12) Patent Application Publication
(10) Pub. No.: US 2026/0112155 A1
(43) Pub. Date: Apr. 23, 2026

(54) CROP PHENOTYPE DATA FUSION METHOD AND APPARATUS, ELECTRONIC DEVICE AND STORAGE MEDIUM

(71) Applicant: Information Technology Research Center, Beijing Academy of Agriculture and Forestry Sciences, Beijing (CN)

(72) Inventors: Wenbo GOU, Beijing (CN); Xinyu GUO, Beijing (CN); Jiangchuan FAN, Beijing (CN); Weiliang WEN, Beijing (CN); Si YANG, Beijing (CN)

(73) Assignee: Information Technology Research Center, Beijing Academy of Agriculture and Forestry Sciences, Beijing (CN)

(21) Appl. No.: 19/363,700

(22) Filed: Oct. 21, 2025

(30) Foreign Application Priority Data
Oct. 21, 2024 (CN) 202411466008.7

(51) Int. Cl. G06V 10/80; G01N 21/84; G06T 5/70; G06T 7/00; G06T 7/70; G06V 10/30; G06V 10/82; G06V 20/10

(52) U.S. Cl. CPC G06V 10/80; G01N 21/84; G06T 5/70; G06T 7/0012; G06T 7/70; G06V 10/30; G06V 10/82; G06V 20/188; G01N 2021/8466; G06T 2207/20081; G06T 2207/20084; G06T 2207/20221; G06T 2207/30188

(57) ABSTRACT

A crop phenotype data fusion method and apparatus, an electronic device and a storage medium are provided. The method includes: inputting target data corresponding to the three-dimensional first to-be-fused crop phenotype data among the to-be-fused crop phenotype data into a weight adjustment model; acquiring a weight value corresponding to each first to-be-fused crop phenotype datum output by the weight adjustment model; and performing data fusion on the plurality of to-be-fused crop phenotype data based on the weight value corresponding to each first to-be-fused crop phenotype data and intrinsic and extrinsic parameter data of the crop phenotype sensors that collect the plurality of to-be-fused crop phenotype data. The target data includes environmental data when collecting crop phenotype data, relative position information between the crop phenotype sensors and the crop, and the target parameter values of the crop phenotype data. The target parameter values include signal-to-noise ratios and/or feature entropies.

### CROSS-REFERENCE TO THE RELATED APPLICATIONS

This application is based upon and claims priority to Chinese Patent Application No. 202411466008.7, filed on Oct. 21, 2024, the entire contents of which are incorporated herein by reference

### TECHNICAL FIELD

The present disclosure relates to the technical field of electronic digital data processing, and in particular to a crop phenotype data fusion method and an apparatus, an electronic device and a storage medium.

### BACKGROUND

A plant phenotype refers to the external observable morphology and characteristics of an individual plant, including features such as its sizes, shapes, structures, flowers, leaves, stems, roots, etc. The plant phenotype is the result of the interaction between the plant genome and the environment, which can reflect the adaptation and growth of plants to the environment.

Crop phenotype data from different dimensions can be acquired by using a crop phenotype platform equipped with various phenotype sensors. Common phenotype sensors mainly include lidar sensors, multispectral image sensors, visible light image sensors, infrared thermal imaging sensors and depth image sensors, etc.

Data fusion performed on crop phenotype data from or with different dimensions is of great significance in improving data precision and integrity, reducing data redundancy and uncertainty, improving decision support ability, promoting agricultural informatization and intelligence, and promoting multidisciplinary intersection and integration. However, the traditional crop phenotype data fusion methods based on related technologies have problems that the fusion efficiency is low and the fusion effect is poor when fusing the crop phenotype data from different dimensions and/or different periods.

Therefore, how to improve the fusion efficiency and the fusion effect of crop phenotype data fusion is a technical problem that needs to be solved urgently in this field.

### SUMMARY

The present disclosure provides a method and apparatus, an electronic device and a storage medium, thus solving the defects in the prior art that the fusion efficiency is low and the fusion effect is poor when fusing the crop phenotype data from different dimensions, and achieving the purpose of improving the fusion efficiency and the fusion effect of crop phenotype data fusion.

The present disclosure provides a crop phenotype data fusion method, including the following steps:
acquiring a plurality of to-be-fused crop phenotype data, where the plurality of to-be-fused crop phenotype data includes one or more of crop phenotype data of a target crop and crop phenotype data of the target crop in a plurality of growth stages, collected by different types of crop phenotype sensors;
acquiring intrinsic and extrinsic parameter data of the crop phenotype sensors when collecting the plurality of to-be-fused crop phenotype data, as well as target data corresponding to first to-be-fused crop phenotype data, where the first to-be-fused crop phenotype data is three-dimensional data from the plurality of to-be-fused crop phenotype data, the target data includes environmental data when collecting the crop phenotype data, relative position information between the crop phenotype sensors that collect the crop phenotype data and a crop, and target parameter values of the crop phenotype data, and the target parameters values include signal-to-noise ratios and/or feature entropies;
inputting all the target data corresponding to the first to-be-fused crop phenotype data into a weight adjustment model, and acquiring a weight value corresponding to each first to-be-fused crop phenotype datum output by the weight adjustment model, where the weight adjustment model is obtained by training based on a target datum corresponding to each sample crop phenotype datum in a sample data set and a weight value corresponding to each sample crop phenotype datum, and sample crop phenotype data includes crop phenotype data of a sample crop collected by the different types of crop phenotype sensors and crop phenotype data of the sample crop in the plurality of growth stages; and
performing data fusion on the plurality of to-be-fused crop phenotype data based on a weight value corresponding to each first to-be-fused crop phenotype datum and the intrinsic and extrinsic parameter data of the crop phenotype sensors that collects the plurality of to-be-fused crop phenotype data, and so as to obtain fused data corresponding to the plurality of to-be-fused crop phenotype data; and
inputting the fused data of the target crop into a trained estimation model to output a characteristic indicator of the target crop, wherein the trained estimation model is obtained by training a neural network model based on sample fused data and a corresponding characteristic indicator.

In some embodiments, the crop phenotype sensors include one or more of a laser radar sensor, a depth image sensor, a multispectral image sensor, a visible light image sensor, and an infrared thermal imaging sensor, and the laser radar sensor and the depth image sensor are configured to collect the first to-be-fused crop phenotype data which includes three-dimensional imaging information, and the multispectral image sensor, the visible light image sensor, and the infrared thermal imaging sensor are configured to collect second to-be-fused crop phenotype data which includes two-dimensional imaging information, where the second to-be-fused crop phenotype data is crop phenotype data except the first to-be-fused crop phenotype data in the plurality of to-be-fused crop phenotype data; and
where the fused data includes environmental information of the target crop, spatiotemporal information, and one or more of the two-dimensional imaging information and the three-dimensional imaging information of the target crop.

In some embodiments, the crop phenotype sensors include a multispectral image sensor, and the fused data includes two-dimensional imaging information, environmental information that includes air temperature and soil moisture, and spatiotemporal information, and
where based on the fused data, the trained estimation model outputs a water stress risk index (WSI), and wherein the method further comprises: when the WSI is higher than a predetermined threshold, sending a signal to an existing irrigation system to instruct the existing irrigation system performing irrigation.

In some embodiments, the crop phenotype sensors includes an infrared thermal imaging sensor and a visible light image sensor, and the fused data includes two-dimensional imaging information that includes RGB imaging data and thermal imaging data, environmental information that includes air temperature and soil moisture, and spatiotemporal information, and
where based on the fused data, the trained estimation model outputs a disease risk index (DRI), and wherein the method further comprises: when the DRI is higher than a predetermined threshold, sending a signal to an existing aerial spraying system to instruct the existing aerial spraying system performing spraying.

According to the crop phenotype data fusion method provided by the present disclosure, the weight value corresponding to each sample crop phenotype datum is acquired based on following steps:
acquiring a first weight score corresponding to each sample crop phenotype datum based on a target parameter value of the sample crop phenotype datum, acquiring a second weight score corresponding to the sample crop phenotype datum based on the relative position information between a sample crop phenotype sensor that collects the sample crop phenotype datum and the sample crop, acquiring a third weight score corresponding to the sample crop phenotype datum based on environmental data when collecting the sample crop phenotype datum and a type of the sample crop phenotype sensor, and acquiring a fourth weight score corresponding to the sample crop phenotype datum based on a growth stage of the sample crop when collecting the sample crop phenotype datum and the type of the sample crop phenotype sensors; and
calculating the weight value corresponding to the sample crop phenotype datum based on the first weight score, the second weight score, the third weight score and the fourth weight score corresponding to the sample crop phenotype datum.

According to the crop phenotype data fusion method provided by the present disclosure, the performing data fusion on the plurality of to-be-fused crop phenotype data based on the weight value corresponding to each first to-be-fused crop phenotype datum and intrinsic and extrinsic parameter data of the crop phenotype sensors that collects the plurality of to-be-fused crop phenotype data, so as to obtain fused data corresponding to the plurality of to-be-fused crop phenotype data, includes:
denoising each to-be-fused crop phenotype datum to acquire a denoised to-be-fused crop phenotype datum;
performing initial alignment on the denoised to-be-fused crop phenotype datum based on intrinsic and extrinsic parameter data of a crop phenotype sensor that collects the to-be-fused crop phenotype datum, so as to acquire a to-be-fused crop phenotype datum after initial alignment;
performing data fusion on all first to-be-fused crop phenotype data after initial alignment based on the weight values corresponding to all first to-be-fused crop phenotype data, so as to acquire first fused data; and
performing data fusion on all second to-be-fused crop phenotype data after initial alignment and the first fused data, so as to obtain the fused data, where the second to-be-fused crop phenotype data is crop phenotype data except the first to-be-fused crop phenotype data in the plurality of to-be-fused crop phenotype data.

According to the crop phenotype data fusion method provided by the present disclosure, the acquiring a first weight score corresponding to each sample crop phenotype datum based on a target parameter value of the sample crop phenotype datum, includes:
determining the target parameter value of the sample crop phenotype datum as an independent variable, determining the first weight score corresponding to the sample crop phenotype datum as a dependent variable, and calculating the first weight score corresponding to the sample crop phenotype datum based on the target parameter value of the sample crop phenotype datum and a positive correlation function, where the positive correlation function is used for describing a positive correlation relationship between the independent variable and the dependent variable;
where the acquiring a second weight score corresponding to the sample crop phenotype datum based on the relative position information between a sample crop phenotype sensor that collects the sample crop phenotype datum and the sample crop includes:
acquiring a distance between the sample crop phenotype sensor and the sample crop and a vertical distance between the sample crop and a target reference line based on the relative position information between the sample crop phenotype sensor and the sample crop, where the target reference line is a central axis of a field of view of the sample crop phenotype sensor;
determining the distance as an independent variable, determining a first sub-weight score corresponding to the sample crop phenotype datum as a dependent variable, calculating the first sub-weight score corresponding to the sample crop phenotype datum based on the distance and the positive correlation function, determining the vertical distance as an independent variable, determining a second sub-weight score corresponding to the sample crop phenotype datum as a dependent variable, and calculating the second sub-weight score corresponding to the sample crop phenotype datum based on the distance and a negative correlation function; and
calculating the second weight score corresponding to the sample crop phenotype datum based on the first sub-weight score and the second sub-weight score corresponding to the sample crop phenotype datum;
where the acquiring a third weight score corresponding to the sample crop phenotype datum based on environmental data when collecting the sample crop phenotype datum and a type of the sample crop phenotype sensors includes:
acquiring a first matching degree between environmental data when collecting the sample crop phenotype datum and the type of the sample crop phenotype sensors; and
determining the first matching degree as an independent variable, determining the third weight score corresponding to the sample crop phenotype datum as a dependent variable, and calculating the third weight score corresponding to the sample crop phenotype datum based on the first matching degree and the positive correlation function;
where the acquiring a fourth weight score corresponding to the sample crop phenotype datum based on a growth stage of the sample crop when collecting the sample crop phenotype datum and the type of the sample crop phenotype sensor includes:
acquiring a second matching degree between the growth stage of the sample crop when collecting the sample crop phenotype datum and the type of the sample crop phenotype sensor;
and determining the second matching degree as an independent variable, determining the fourth weight score corresponding to the sample crop phenotype datum as a dependent variable, and calculating the fourth weight score corresponding to the sample crop phenotype datum based on the second matching degree and the positive correlation function.

According to the crop phenotype data fusion method provided by the present disclosure, the calculating the weight value corresponding to the sample crop phenotype datum based on the first weight score, the second weight score, the third weight score and the fourth weight score corresponding to the sample crop phenotype datum, includes:
acquiring a time consistency evaluation value of the sample crop phenotype datum;
calculating a product of the first weight score, the second weight score, the third weight score and the fourth weight score of the sample crop phenotype datum as an intermediate result; and
calculating a quotient of the intermediate result divided by the time consistency evaluation value of the sample crop phenotype datum as the weight value corresponding to the sample crop phenotype datum.

According to the crop phenotype data fusion method provided by the present disclosure, the performing data fusion on all first to-be-fused crop phenotype data after initial alignment based on weight value corresponding to all first to-be-fused crop phenotype data, so as to acquire first fused data, includes:
performing data fusion on the first to-be-fused crop phenotype data after initial alignment using an iterative closest point algorithm based on the weight value corresponding to the first to-be-fused crop phenotype data, so as to acquire the first fused data;
where the performing data fusion on each second to-be-fused crop phenotype data after initial alignment and the first fused data, so as to obtain the fused data, where the second to-be-fused crop phenotype data is crop phenotype data except the first to-be-fused crop phenotype data in the plurality of to-be-fused crop phenotype data, includes:
extracting features of the second to-be-fused crop phenotype data after initial alignment, so as to acquire feature information corresponding to the second to-be-fused crop phenotype data after initial alignment; and
mapping the feature information corresponding to the second to-be-fused crop phenotype data after initial alignment into the first fused data, so as to obtain the fused data.

The present disclosure further provides a crop phenotype data fusion apparatus, including the following modules:
a first data acquisition module, which is configured to acquire a plurality of to-be-fused crop phenotype data, where the plurality of to-be-fused crop phenotype data includes one or more of crop phenotype data of a target crop and crop phenotype data of the target crop in a plurality of growth stages, collected by different types of crop phenotype sensors;
a second data acquisition module, which is configured to acquire intrinsic and extrinsic parameter data of the crop phenotype sensors when collecting the plurality of to-be-fused crop phenotype data, as well as target data corresponding to first to-be-fused crop phenotype data, where the first to-be-fused crop phenotype data is three-dimensional data from the plurality of to-be-fused crop phenotype data, the target data includes environmental data when collecting the crop phenotype data, relative position information between the crop phenotype sensors that collect the crop phenotype data and a crop, and target parameter values of the crop phenotype data, and the target parameter values include signal-to-noise ratios and/or feature entropies;
a dynamic weight determining module, which is configured to input all the target data corresponding to the first to-be-fused crop phenotype data into a weight adjustment model, and acquire a weight value corresponding to each first to-be-fused crop phenotype datum output by the weight adjustment model, where the weight adjustment model is obtained by training based on a target datum corresponding to each sample crop phenotype datum in a sample data set and a weight value corresponding to each sample crop phenotype datum, and sample crop phenotype data includes crop phenotype data of a sample crop collected by the different types of crop phenotype sensors and crop phenotype data of the sample crop in the plurality of growth stages;
a multi-source data fusion module, which is configured to perform data fusion on the plurality of to-be-fused crop phenotype data based on a weight value corresponding to each first to-be-fused crop phenotype datum and intrinsic and extrinsic parameter data of the crop phenotype sensors that collect the plurality of to-be-fused crop phenotype data, so as to obtain fused data corresponding to the plurality of to-be-fused crop phenotype data; and
a characteristic estimation module, which is configured to receive the fused data of the target crop to output a characteristic indicator of the target crop, wherein the characteristic estimation module is obtained by training a neural network model based on sample fused data and a corresponding characteristic indicator.

The present disclosure further provides an electronic device, including a memory, a processor, and a computer program stored in the memory and operable on the processor, where the processor, when executing the computer program, implements the crop phenotype data fusion method described above.

The present disclosure further provides a non-transient computer-readable storage medium on which a computer program is stored, where the computer program, when executed by a processor, implements the crop phenotype data fusion method described above.

The present disclosure further provides a computer program product, including a computer program, where the computer program, when executed by a processor, implements the crop phenotype data fusion method described above.

According to a crop phenotype data fusion method and apparatus, an electronic device and a storage medium provided by the present disclosure, all the target data corresponding to the first to-be-fused crop phenotype data are input into a weight adjustment model. After a weight value corresponding to each first to-be-fused crop phenotype datum output by the weight adjustment model is acquired, data fusion is performed on the plurality of to-be-fused crop phenotype data based on a weight value corresponding to each first to-be-fused crop phenotype datum and intrinsic and extrinsic parameter data of the crop phenotype sensors that collect the plurality of to-be-fused crop phenotype data, so as to obtain fused data corresponding to the plurality of to-be-fused crop phenotype data. The data quality of the sample crop phenotype data, the relative position relationship between the sample crop phenotype sensor when collecting the sample crop phenotype data and the sample crop, the environmental factors in which the sample crop phenotype sensor collects the sample crop phenotype data, and the influence of the growth stages of the sample crop on the sample crop phenotype data, can be taken into account comprehensively. The weight value corresponding to the sample crop phenotype data can be acquired more accurately, so that the weight value corresponding to each to-be-fused crop phenotype data can be acquired more efficiently and accurately through deep learning. The fusion efficiency and the fusion effect of crop phenotype data fusion can be improved. A more accurate data basis can be provided for high-precision three-dimensional modeling, crop feature extraction and other application scenes of precision agriculture, which has broad application prospects.

### BRIEF DESCRIPTION OF THE DRAWINGS

In order to explain the technical solution of the present disclosure or the prior art more clearly, the drawings needed in the description of the embodiments or the prior art will be briefly introduced hereinafter. It is apparent that the drawings in the following description are some embodiments of the present disclosure. For those skilled in the art, other drawings can be obtained according to these drawings without paying creative labor.

FIG. 1 is a schematic flow chart of a crop phenotype data fusion method according to the present disclosure.

FIG. 2 is a schematic structural diagram of a crop phenotype data fusion apparatus according to the present disclosure.

FIG. 3 is a schematic structural diagram of an electronic device according to the present disclosure.

### DETAILED DESCRIPTION OF THE EMBODIMENTS

In order to make the purpose, the technical solution and the advantages of the present disclosure more clear, the technical solution in the present disclosure will be described clearly and completely with reference to the attached drawings hereinafter. Apparently, the described embodiments are some of the embodiments of the present disclosure, rather than all of the embodiments. Based on the embodiments in the present disclosure, all other embodiments obtained by those skilled in the art without paying creative labor fall into the scope of protection of the present disclosure.

In the description of the present disclosure, it should be noted that unless otherwise specified and limited, the terms “install”, “link” and “connect” should be broadly understood, for example, may be interpreted as fixed connection, detachable connection or integrated connection; or mechanical connection or electrical connection; or direct connection, or indirect connection through an intermediate medium; or internal communication of two elements. For those skilled in the art, the specific meanings of the above terms in the present disclosure can be understood according to specific situations.

In the description of the present disclosure, the terms “first” and “second” are used to distinguish similar objects, rather than describe a specific order or sequence. It should be understood that the data used in this way can be interchanged where appropriate, so that the embodiments of the present disclosure can be implemented in an order other than those illustrated or described here. Furthermore, the terms “first”, “second” and the like are usually used to distinguishing objects of one category, and are not intended to limit the number of objects. For example, there may be one or more first objects. In addition, in the description of the present disclosure, “and/or” means at least one of the connected objects, and the character “/” generally means that the previous and next associated objects form an “or” relationship.

It should be noted that when data fusion is performed on the crop phenotype data from different dimensions and/or different periods based on the traditional crop phenotype data fusion methods of related technologies, fixed weights are usually assigned to the crop phenotype data from different dimensions, and then the crop phenotype data from different dimensions are fused based on the weight of the crop phenotype data of each dimension.

However, when the traditional phenotype data fusion methods perform the crop phenotype data fusion from different dimensions and/or different periods, the influence of factors such as the type of crops, the growth stages of crops, environmental changes and data source quality on data fusion is ignored, so that the fusion effect achieved by performing the data fusion on the crop phenotype data from different dimensions based on the traditional crop phenotype data fusion methods of related technologies is poor, and the advantages of multi-dimensional crop phenotype data cannot be made full use of.

Due to a long processing flow of performing data fusion on the crop phenotype data from different dimensions and/or different periods using the traditional crop phenotype data fusion methods, the fusion efficiency of data fusion on the crop phenotype data from different dimensions based on the traditional crop phenotype data fusion methods is low, such that the traditional crop phenotype data fusion methods cannot meet the requirements of high-timeliness data analysis, and the application of the traditional crop phenotype data fusion methods in scenes requiring rapid response and real-time decision-making is limited.

When the traditional phenotype data fusion methods perform data fusion on the crop phenotype data from different dimensions and/or different periods, there is a lack of an intelligent adjustment strategy to explore the potential relevance and complementarity between crop phenotype data from different dimensions and/or different periods, which leads to the difficulty in achieving effective feature enhancement and accurate crop characterization of the fused crop phenotype data obtained by fusion, and further affects the application effect of the traditional crop phenotype data fusion method in the fields such as precision agriculture and environmental monitoring.

It is difficult to for the traditional phenotype data fusion method to cope with the dynamic changes of the crop growth environment and the sensor state, that is its adaptability is poor, which leads to the inability of the traditional phenotype data fusion method to be flexibly adjusted according to the actual situation, and limits the application of the traditional crop phenotype data fusion method in the complex agricultural environment and other dynamic change scenes.

Therefore, the present disclosure provides a crop phenotype data fusion method, which dynamically adjusts the weight of different data sources in data fusion by analyzing the quality and features of different data sources, thereby improving the relevance, utilization efficiency and timeliness of data fusion, solving the problems of fixed weight, low timeliness and low data utilization rate in related technologies, and providing a more flexible, efficient and intelligent multi-source data fusion solution.

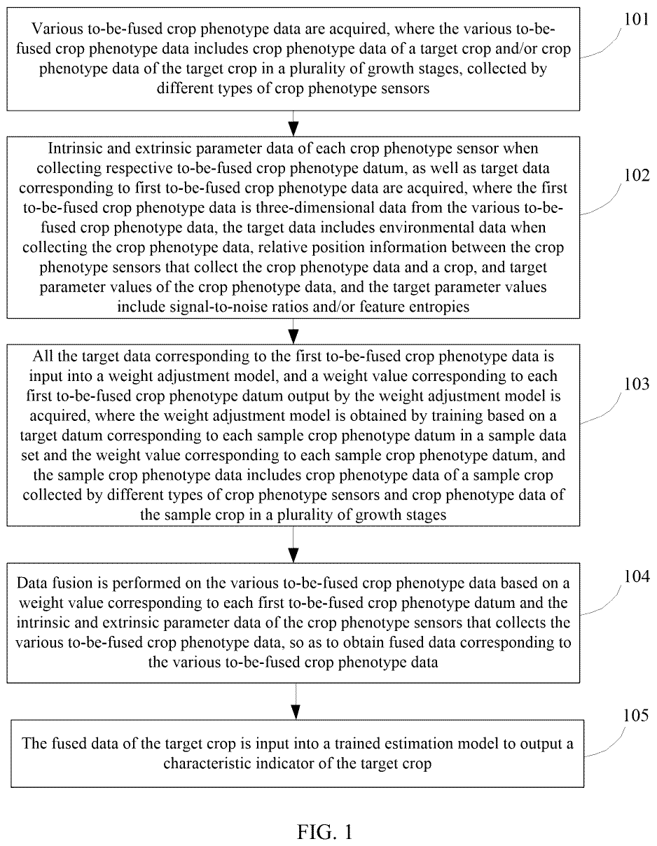

The crop phenotype data fusion method of the present disclosure will be described with reference to FIG. 1 hereinafter.

FIG. 1 is a schematic flow chart of a crop phenotype data fusion method according to the present disclosure. As shown in FIG. 1, the method includes the following steps 101-105. In step 101, various to-be-fused crop phenotype data are acquired, where the various to-be-fused crop phenotype data includes crop phenotype data of a target crop and/or crop phenotype data of the target crop in a plurality of growth stages, collected by different types of crop phenotype sensors.

It should be noted that the execution subject of the embodiment of the present disclosure is a crop phenotype data fusion apparatus. The crop phenotype data fusion apparatus can be configured in an electronic device such as a computer and a server.

Specifically, the various to-be-fused crop phenotype data is a fusion object of the crop phenotype data fusion method according to the present disclosure.

It should be noted that the various to-be-fused crop phenotype data includes crop phenotype data of a target crop and/or crop phenotype data of the target crop in a plurality of growth stages, collected by different types of crop phenotype sensors.

It can be understood that various to-be-fused crop phenotype data can include crop phenotype data of the target crop in different growth stages collected by the same crop phenotype sensor. Various to-be-fused crop phenotype data can further include the phenotype data of the target crop in the same growth stage collected by different crop phenotype sensors.

The fused data may comprise multiple dimensions, such as environmental and supplementary data, imaging data, concrete data, and spatiotemporal data. In some embodiments, the fused data is consist of four mutually corresponding dimensions:
The first dimension corresponds to the environmental information of the target crop which may include environmental data related to crop growth and development (including but not limited to air temperature T_air, humidity RH, wind speed, soil humidity and so on) and supplementary data such as sensor exposure time and spectral gain;
The second dimension corresponds to the two-dimensional imaging information of the target crop which may include RGB image (for example, with a resolution of 1920 by 1080 and a bit depth of Aug. 10, 2012 bits per channel), multispectral image (for example, 5-8 channel reflectance maps), and thermal image (for example, with a resolution of 640 by 512 and a 14-bit depth);
The third dimension corresponds to the three-dimensional imaging information of the target crop which includes concrete data such as point clouds (for example, LiDAR point cloud with approximately 100,000 to 200,000 points per frame and each point being denoted as {x, y, z, intensity, t}) and depth maps;
The fourth dimension corresponds to the spatiotemporal information which characterizes the temporal sequence for respective dimension data and the spatial mapping relationship between digital data and physical crops.

In summary, the fused data constitutes a comprehensive multidimensional characterization data system tailored to crop characteristics, integrating one or more of environmental conditions, color-texture features, physiological-biochemical properties, three-dimensional morphology, spatiotemporal transformations for holistic representation and so on.

It can be understood that the target crop in the embodiment of the present disclosure can be determined based on actual demand. The target crop is not specifically limited in the embodiment of the present disclosure.

It should be noted that different types of crop phenotype sensors in the embodiment of the present disclosure may include, but are not limited to, lidar sensors, multispectral image sensors, visible light image sensors, infrared thermal imaging sensors, depth image sensors, and the like.

It can be understood that the crop phenotype data collected by crop phenotype sensors such as lidar sensors and depth image sensors are three-dimensional, while the crop phenotype data collected by crop phenotype sensors such as multispectral image sensors, visible light image sensors and infrared thermal imaging sensors are two-dimensional.

In the embodiment of the present disclosure, various to-be-fused crop phenotype data can be acquired in various manners. For example, in the embodiment of the present disclosure, various to-be-fused crop phenotype data can be acquired based on user input. Alternatively, in the embodiment of the present disclosure, various to-be-fused crop phenotype data sent by other electronic devices can also be received. In the embodiment of the present disclosure, the specific manner of acquiring various to-be-fused crop phenotype data is not limited.

In step 102, intrinsic and extrinsic parameter data of each crop phenotype sensor when collecting respective to-be-fused crop phenotype datum, as well as target data corresponding to first to-be-fused crop phenotype data are acquired, where the first to-be-fused crop phenotype data is three-dimensional data from the various to-be-fused crop phenotype data, the target data includes environmental data when collecting the crop phenotype data, relative position information between the crop phenotype sensors that collect the crop phenotype data and a crop, and target parameter values of the crop phenotype data, and the target parameter values include signal-to-noise ratios and/or feature entropies.

It should be noted that in the embodiment of the present disclosure, when the crop phenotype sensor collects the crop phenotype data, the intrinsic and extrinsic parameter data of the crop phenotype sensor when collecting the data are recorded. Therefore, in the embodiment of the present disclosure, the intrinsic and extrinsic parameter data of each crop phenotype sensor when collecting respective to-be-fused crop phenotype datum can be acquired by data query.

It should be noted that in the embodiment of the present disclosure, the three-dimensional to-be-fused crop phenotype data collected by crop phenotype sensors such as lidar sensors and depth image sensors among various to-be-fused crop phenotype data are determined as the first to-be-fused crop phenotype data. The two-dimensional to-be-fused crop phenotype data collected by crop phenotype sensors such as multispectral image sensors, visible light image sensors and infrared thermal imaging sensors among various to-be-fused crop phenotype data are determined as second to-be-fused crop phenotype data.

It should be noted that in the embodiment of the present disclosure, various to-be-fused crop phenotype data only includes one or more first to-be-fused crop phenotype data and/or one or more second to-be-fused crop phenotype data.

It should be noted that in the embodiment of the present disclosure, when the crop phenotype sensor collects the crop phenotype data, an environmental perception sensor is used to collect the environmental data of the crop phenotype sensor during the collection of crop phenotype data. Therefore, in the embodiment of the present disclosure, the environmental data of each crop phenotype sensor when collecting each to-be-fused crop phenotype datum can be acquired by data query as the target data corresponding to each to-be-fused crop phenotype datum.

After acquiring the intrinsic and extrinsic parameter data of each crop phenotype sensor when collecting respective to-be-fused crop phenotype datum, the relative position information between each crop phenotype sensor when collecting various to-be-fused crop phenotype data and the target crop can be calculated based on the intrinsic and extrinsic parameter data of each crop phenotype sensor when collecting respective to-be-fused crop phenotype datum as the target data corresponding to each to-be-fused crop phenotype datum.

After acquiring each to-be-fused crop phenotype datum, the signal-to-noise ratio and/or the feature entropy of each to-be-fused crop phenotype datum can be calculated by numerical calculation as the target data corresponding to each to-be-fused crop phenotype datum.

In step 103, all the target data corresponding to the first to-be-fused crop phenotype data is input into a weight adjustment model, and a weight value corresponding to each first to-be-fused crop phenotype datum output by the weight adjustment model is acquired, where the weight adjustment model is obtained by training based on a target datum corresponding to each sample crop phenotype datum in a sample data set and the weight value corresponding to each sample crop phenotype datum, and the sample crop phenotype data includes crop phenotype data of a sample crop collected by different types of crop phenotype sensors and crop phenotype data of the sample crop in a plurality of growth stages.

It should be noted that in the embodiment of the present disclosure, the sample data set can be acquired in various manners, for example, the sample data set can be acquired based on the user input. Alternatively, sample data sent by other electronic devices can also be received. In the embodiment of the present disclosure, the specific manner of acquiring the sample data set is not limited.

Optionally, in the embodiment of the present disclosure, a crop phenotype data set with a good fusion effect after data fusion can be selected from the crop phenotype data set that has been subjected to data fusion, and then each crop phenotype datum in the crop phenotype data set with a good fusion effect after data fusion can be determined as a sample crop phenotype datum. Thereafter, each sample crop phenotype datum and the weight value corresponding to each sample crop phenotype datum can be determined as a sample data set.

After acquiring the sample data set, the target data corresponding to each sample crop phenotype datum can be used as the training sample, and the weight value corresponding to each sample crop phenotype datum can be used as the sample label, so as to train the weight adjustment model to obtain the trained weight adjustment model.

It can be understood that in the embodiment of the present disclosure, a plurality of sample data sets are provided.

It can be understood that in the embodiment of the present disclosure, the sample crop phenotype data is three-dimensional.

After the trained weight adjustment model is obtained, the target data corresponding to each first to-be-fused crop phenotype datum is input into the trained weight adjustment model, so that a weight value corresponding to each first to-be-fused crop phenotype datum output by the weight adjustment model can be acquired.

It should be noted that in order to further improve the adaptability of the weight adjustment model, a self-learning mechanism is introduced in the embodiment of the present disclosure. The weight adjustment model can automatically optimize the weight adjustment strategy and the fusion algorithm through retrospective analysis of collected historical data. The self-learning mechanism includes the following core modules: a historical data retrospective module and an incremental learning mechanism. A historical data retrospective module extracts scene features with a good fusion effect by analyzing the results of historical multi-source data, and feeds the scene features back to the weight adjustment model for model optimization.

In the incremental learning mechanism, after each new data collection is completed, the weight adjustment model performs incremental learning based on the latest data and continuously adjusts the fusion parameters, so that the model can still deal with new sensor configurations or environmental changes efficiently.

Through the self-learning mechanism, the crop phenotype data fusion method provided by the present disclosure can continuously optimize and improve the data fusion effect when facing complex scenes, dynamically changing sensor configurations or environmental conditions.

As an optional embodiment, the weight value corresponding to each sample crop phenotype datum is acquired based on the following steps: acquiring a first weight score corresponding to each sample crop phenotype datum based on a target parameter value of the sample crop phenotype datum, acquiring a second weight score corresponding to the sample crop phenotype datum based on the relative position information between a sample crop phenotype sensor that collects the sample crop phenotype datum and the sample crop, acquiring a third weight score corresponding to the sample crop phenotype datum based on environmental data when collecting the sample crop phenotype datum and a type of the sample crop phenotype sensor, and acquiring a fourth weight score corresponding to the sample crop phenotype datum based on a growth stage of the sample crop when collecting the sample crop phenotype datum and the type of the sample crop phenotype sensor.

Specifically, in the embodiment of the present disclosure, by means of numerical calculation, mathematical statistics and deep learning, a first weight score corresponding to each sample crop phenotype datum is acquired based on the target parameter value of the sample crop phenotype datum, a second weight score corresponding to the sample crop phenotype datum is acquired based on the relative position information between the sample crop phenotype sensor that collects the sample crop phenotype datum and the sample crop, a third weight score corresponding to the sample crop phenotype datum is acquired based on environmental data when collecting the sample crop phenotype datum and the type of the sample crop phenotype sensor, and a fourth weight score corresponding to the sample crop phenotype datum is acquired based on the growth stage of the sample crop when collecting the sample crop phenotype datum and the type of the sample crop phenotype sensor.

As an optional embodiment, a first weight score corresponding to each sample crop phenotype datum is acquired based on the target parameter value of the sample crop phenotype datum, which includes: determining the target parameter value of the sample crop phenotype data as an independent variable, determining the first weight score corresponding to the sample crop phenotype datum as a dependent variable, and calculating the first weight score corresponding to the sample crop phenotype datum based on the target parameter value of the sample crop phenotype datum and a positive correlation function, where the positive correlation function is used for describing a positive correlation relationship between the independent variable and the dependent variable.

It should be noted that the positive correlation relationship means that if the independent variable changes from large to small, the dependent variable also changes from large to small, and if the independent variable changes from small to large, the dependent variable also changes from small to large. The positive correlation function in the embodiment of the present disclosure may include, but is not limited to, a linear positive correlation function, a quadratic function, an exponential function and a logarithmic function. The positive correlation function in the embodiment of the present disclosure can be determined based on prior knowledge and/or actual situation. The positive correlation function is not specifically limited in the embodiment of the present disclosure.

It can be understood that the signal-to-noise ratio and the feature entropy are important indicators to measure the data quality. The higher the signal-to-noise ratio of data, the higher the data quality, the higher the feature entropy of data, and the higher the information contained in data.

Therefore, in the embodiment of the present disclosure, the target parameter value of the sample crop phenotype data is determined as an independent variable. The first weight score corresponding to the sample crop phenotype data is determined as a dependent variable. The first weight score corresponding to the sample crop phenotype data is calculated based on the target parameter value of the sample crop phenotype data and a positive correlation function. The first weight score corresponding to the sample crop phenotype data which has a positive correlation relationship with the target parameter value of the sample crop phenotype data is acquired.

A second weight score corresponding to the sample crop phenotype datum is acquired based on the relative position information between the sample crop phenotype sensor that collects the sample crop phenotype datum and the sample crop, which includes: acquiring a distance between the sample crop phenotype sensor and the sample crop and a vertical distance between the sample crop and a target reference line based on the relative position information between the sample crop phenotype sensor and the sample crop, where the target reference line is a central axis of a field of view of the sample crop phenotype sensor.

The distance is determined as an independent variable. A first sub-weight score corresponding to the sample crop phenotype datum is determined as a dependent variable. The first sub-weight score corresponding to the sample crop phenotype datum is calculated based on the distance and the positive correlation function. The vertical distance is determined as an independent variable. A second sub-weight score corresponding to the sample crop phenotype datum is determined as a dependent variable. The second sub-weight score corresponding to the sample crop phenotype datum is calculated based on the distance and the negative correlation function.

The second weight score corresponding to the sample crop phenotype datum is calculated based on the first sub-weight score and the second sub-weight score corresponding to the sample crop phenotype datum.

It can be understood that when crop phenotype sensors are used to collect crop phenotype data, crop phenotype sensors are usually arranged in different positions. For example, visible light image sensors can be arranged in unmanned aerial vehicles to acquire wide-area views, while lidar sensors are usually arranged on the ground to acquire point cloud data with rich details. Therefore, it is necessary to consider the relative position relationship between crop phenotype sensors and crops in the process of data fusion.

For three-dimensional sample crop phenotype data, the smaller the distance between the sample crop phenotype sensor and the sample crop is and the more the sample crop is close to the center of the field of view of the sample crop phenotype sensor, the more the crop features included in the acquired sample crop phenotype data is.

Therefore, in the embodiment of the present disclosure, the distance between the sample crop phenotype sensor and the sample crop is determined as an independent variable. The first sub-weight score corresponding to the sample crop phenotype data is determined as a dependent variable. Thereafter, the first sub-weight score corresponding to the sample crop phenotype data is calculated based on the distance between the sample crop phenotype sensor and the sample crop and the positive correlation function. The first weight score corresponding to the sample crop phenotype data which has a positive correlation relationship with the distance between the sample crop phenotype sensor and the sample crop is acquired.

It should be noted that in the embodiment of the present disclosure, the vertical distance between the sample crop and the central axis of the field of view of the sample crop phenotype sensor is used to describe the position of the sample crop in the field of view of the sample crop phenotype sensor. The smaller the vertical distance between the sample crop and the central axis of the field of view of the sample crop phenotype sensor is, the more the crop is close to the center of the field of view of the crop phenotype sensor.

Accordingly, in the embodiment of the present disclosure, the vertical distance between the sample crop and the central axis of the field of view of the sample crop phenotype sensor is determined as an independent variable. The second sub-weight score corresponding to the sample crop phenotype data is determined as a dependent variable. The second sub-weight score corresponding to the sample crop phenotype data is calculated based on the vertical distance between the sample crop and the central axis of the field of view of the sample crop phenotype sensor and the negative correlation function. The second sub-weight score corresponding to the sample crop phenotype data which has a negative correlation relationship with the vertical distance between the sample crop and the central axis of the field of view of the sample crop phenotype sensor is acquired.

It should be noted that the negative correlation relationship means that if the independent variable changes from large to small, the dependent variable changes from small to large, and if the independent variable changes from small to large, the dependent variable changes from large to small. The negative correlation function in the embodiment of the present disclosure may include, but is not limited to, a linear negative correlation function, a quadratic function, an exponential function and a logarithmic function. The negative correlation function in the embodiment of the present disclosure can be determined based on prior knowledge and/or actual situation. The negative correlation function is not specifically limited in the embodiment of the present disclosure.

After acquiring the first sub-weight score and the second sub-weight score corresponding to the sample crop phenotype data, the average value of the first sub-weight score and the second sub-weight score corresponding to the sample crop phenotype data can be calculated by numerical calculation as the second weight score corresponding to the sample crop phenotype data.

A third weight score corresponding to the sample crop phenotype datum is acquired based on environmental data when collecting the sample crop phenotype datum and the type of the sample crop phenotype sensor, which includes: acquiring a first matching degree between environmental data when collecting the sample crop phenotype datum and the type of the sample crop phenotype sensor.

The first matching degree is determined as an independent variable. The third weight score corresponding to the sample crop phenotype datum is determined as a dependent variable. The third weight score corresponding to the sample crop phenotype datum is calculated based on the first matching degree and the positive correlation function.

It can be understood that different types of crop phenotype sensors have different confidence levels of crop phenotype data collected in different environments. For example, in the case of high environmental temperature, the confidence level of crop phenotype data collected by infrared thermal imaging sensors is high. In the case of high light intensity, the confidence level of crop phenotype data collected by visible light image sensor is high. In the case of low light intensity, the confidence level of crop phenotype data collected by visible light image sensors is low, while the confidence level of crop phenotype data collected by multi-spectral image sensors and lidar sensors is high. In the case of a high wind speed, the confidence level of crop phenotype data collected by various crop phenotype sensors is low.

Therefore, in the embodiment of the present disclosure, the first matching degree between environmental data when collecting the sample crop phenotype data and the type of the sample crop phenotype sensor is determined as an independent variable. The third weight score corresponding to the sample crop phenotype data is determined as a dependent variable. The third weight score corresponding to the sample crop phenotype data is calculated based on the first matching degree and the positive correlation function. The third weight score corresponding to the sample crop phenotype data which has a positive correlation relationship with the first matching degree is acquired.

It should be noted that the value of environmental data of the sensitive environmental data type in the environmental data when collecting sample crop phenotype data is determined based on the sensitive environmental data type corresponding to the type of the sample crop phenotype sensor. Thereafter, the first matching degree between environmental data when collecting the sample crop phenotype data and the type of the sample crop phenotype sensor can be determined based on the value of environmental data of the sensitive environmental data type in the environmental data when collecting sample crop phenotype data. The sensitive environmental data type corresponding to the type of the sample crop phenotype sensor can be predefined based on prior knowledge and/or actual situation.

For example, based on prior knowledge and/or actual situation, the sensitive environmental data type corresponding to the infrared thermal imaging sensors can be determined as environmental temperature. Therefore, in the case that the sample crop phenotype data is collected by the infrared thermal imaging sensors, the first original matching degree between the environmental data when collecting the sample crop phenotype data and the type of the sample crop phenotype sensor can be determined based on the temperature interval where the environmental temperature is located when the infrared thermal imaging sensor collects the sample crop phenotype data. Based on the wind speed when the infrared thermal imaging sensor collects the sample crop phenotype data, the second original matching degree between the environmental data when collecting the sample crop phenotype data and the type of the sample crop phenotype sensor can be determined. Thereafter, the average value of the first original matching degree and the second original matching degree can be determined as the first matching degree between the infrared thermal imaging sensor and the environmental temperature when the infrared thermal imaging sensor collects the sample crop phenotype data. The corresponding relationship between different temperature intervals and different matching degrees can be determined based on prior knowledge and/or actual situation.

For another example, based on prior knowledge and/or actual situation, the sensitive environmental data type corresponding to the visible light image sensors, the spectral image sensors and the lidar sensors can be determined as light intensity. Therefore, in the case that the sample crop phenotype data is collected by the visible light image sensors, the spectral image sensors or the lidar sensors, the first original matching degree between the environmental data when collecting the sample crop phenotype data and the type of the sample crop phenotype sensor can be determined based on the light intensity interval where the light intensity is located when collecting the sample crop phenotype data. Based on the wind speed when collecting the sample crop phenotype data, the second original matching degree between the environmental data when collecting the sample crop phenotype data and the type of the sample crop phenotype sensor can be determined. Thereafter, the average value of the first original matching degree and the second original matching degree can be determined as the first matching degree between the sample crop phenotype sensors and the environmental temperature when the sample crop phenotype sensor collects sample crop phenotype data. The corresponding relationship between different light intensity intervals and different matching degrees can be determined based on prior knowledge and/or actual situation.

A fourth weight score corresponding to the sample crop phenotype data is acquired based on a growth stage of the sample crop when collecting the sample crop phenotype datum and the type of the sample crop phenotype sensor includes: acquiring a second matching degree between the growth stage of the sample crop when collecting the sample crop phenotype datum and the type of the sample crop phenotype sensor.

The second matching degree is determined as an independent variable. The fourth weight score corresponding to the sample crop phenotype datum is determined as a dependent variable. The fourth weight score corresponding to the sample crop phenotype datum is calculated based on the second matching degree and the positive correlation function.

It should be noted that in different growth stages of crops, the contribution degree of the crop phenotype data collected by different types of crop phenotype sensors to the analysis of the growth state of crops is not the same. For example, in the early growth stage of crops, the color information of leaves is more important for the analysis of the normal state of crops. Therefore, the crop phenotype data collected by the visible light image sensors has a greater contribution degree to the analysis of the growth state of crops, while the crop phenotype data collected by the depth image sensors and the lidar sensors has a smaller contribution degree to the analysis of the growth state of crops. In the middle growth stage and the late growth stage of crops, the height and volume of crops change significantly. The crop phenotype data collected by the depth image sensors and the lidar sensors has a greater contribution degree to the analysis of the growth state of crops.

Therefore, in the embodiment of the present disclosure, the second matching degree between the growth stage of the sample crop when collecting the sample crop phenotype data and the type of the sample crop phenotype sensor is determined as an independent variable. The fourth weight score corresponding to the sample crop phenotype data is determined as a dependent variable. The fourth weight score corresponding to the sample crop phenotype data is calculated based on the second matching degree and the positive correlation function. The fourth weight score corresponding to the sample crop phenotype data which has a positive correlation relationship with the second matching degree is acquired.

It should be noted that the second matching degree can be determined based on the sensitive growth stage corresponding to the type of the sample crop phenotype sensor. The sensitive growth stage corresponding to the type of the sample crop phenotype sensor can be determined based on prior knowledge and/or actual situation.

For example, in the case that the sample crop phenotype data is collected by the visible light image sensors, if the growth stage of the sample crop when collecting the sample crop phenotype data is the early growth stage, the second matching degree between the growth stage of the sample crop when collecting the sample crop phenotype data and the type of the sample crop phenotype sensor can be determined as 1, and if the growth stage of the sample crop when collecting the sample crop phenotype data is not the early growth stage, the second matching degree between the growth stage of the sample crop when collecting the sample crop phenotype data and the type of the sample crop phenotype sensor can be determined as 0.

For example, in the case that the sample crop phenotype data is collected by the depth image sensors, if the growth stage of the sample crop when collecting the sample crop phenotype data is the middle growth stage, the second matching degree between the growth stage of the sample crop when collecting the sample crop phenotype data and the type of the sample crop phenotype sensor can be determined as 1, and if the growth stage of the sample crop when collecting the sample crop phenotype data is the early growth stage, the second matching degree between the growth stage of the sample crop when collecting the sample crop phenotype data and the type of the sample crop phenotype sensor can be determined as 0.

The weight value corresponding to the sample crop phenotype data is calculated based on the first weight score, the second weight score, the third weight score and the fourth weight score corresponding to the sample crop phenotype data.

Specifically, after acquiring the first weight score, the second weight score, the third weight score and the fourth weight score corresponding to the sample crop phenotype data, the weight value corresponding to the sample crop phenotype data can be calculated by numerical calculation.

As an optional embodiment, calculating the weight value corresponding to the sample crop phenotype data based on the first weight score, the second weight score, the third weight score and the fourth weight score corresponding to the sample crop phenotype data, includes: acquiring a time consistency evaluation value of the sample crop phenotype data.

Specifically, because the collecting time of each to-be-fused crop phenotype datum subjected to data fusion is not exactly the same, the problem of time non-synchronization may occur during data fusion. Therefore, in the embodiment of the present disclosure, in the model training stage, the time consistency evaluation value of the sample crop phenotype data is introduced to calculate the weight value corresponding to the sample crop phenotype data.

It should be noted that in the embodiment of the present disclosure, the time consistency evaluation value of the sample crop phenotype data can be used as a measurement standard to measure whether the sample crop phenotype data are consistent at different time points.

The time consistency evaluation value of the sample crop phenotype data can be calculated by the following steps: calculating the time difference ΔT between the time when collecting the sample crop phenotype data and the reference time. The reference time can be predefined based on the actual situation.

Based on the above time difference ΔT, the time consistency evaluation value of the sample crop phenotype data is calculated by the following formula:

$${T}_{i} = {e}^{- αΔ {T}_{i}} ,$$

where Tᵢ denotes a time consistency evaluation value of the i-th sample crop phenotype datum; ΔTᵢ denotes a time difference between the time when collecting the i-th sample crop phenotype datum and the reference time; α denotes a time attenuation factor, which determines the influence degree of the time difference on Tᵢ, and the value of a can be set according to practical application.

The product of the first weight score, the second weight score, the third weight score and the fourth weight score corresponding to the sample crop phenotype data is calculated as an intermediate result.

The quotient of the intermediate result divided by the time consistency evaluation value of the sample crop phenotype data is calculated as the weight value corresponding to the sample crop phenotype data.

Specifically, the weight values corresponding to the sample crop phenotype data can be calculated by the following formula:

$${W}_{i} = \frac{{S}_{i} \cdot {D}_{i} \cdot {C}_{i} \cdot {K}_{i}}{{T}_{i}} ,$$

where Wᵢ denotes a weight value corresponding to the i-th sample crop phenotype data; Sᵢ denotes a first weight score corresponding to the i-th sample crop phenotype data; Dᵢ denotes a second weight score corresponding to the i-th sample crop phenotype data; Cᵢ denotes a third weight score corresponding to the i-th sample crop phenotype data; Kᵢ denotes a fourth weight score corresponding to the i-th sample crop phenotype data.

According to the embodiment of the present disclosure, a first weight score corresponding to the sample crop phenotype data is acquired based on the target parameter value of the sample crop phenotype data. A second weight score corresponding to the sample crop phenotype data is acquired based on the relative position information between the sample crop phenotype sensor that collects the sample crop phenotype data and the sample crop. A third weight score corresponding to the sample crop phenotype data is acquired based on environmental data when collecting the sample crop phenotype data and the type of the sample crop phenotype sensor. A fourth weight score corresponding to the sample crop phenotype data is acquired based on the growth stage of the sample crop when collecting the sample crop phenotype data and the type of the sample crop phenotype sensor. The data quality of the sample crop phenotype data, the relative position relationship between the sample crop phenotype sensor when collecting the sample crop phenotype data and the sample crop, the environmental factors in which the sample crop phenotype sensor collects the sample crop phenotype data, and the influence of the growth stages of the sample crop on the sample crop phenotype data, can be taken into account comprehensively. The weight value corresponding to the sample crop phenotype data can be acquired more accurately. A more accurate data basis can be provided for the weight adjustment model.

In step 104, data fusion is performed on the various to-be-fused crop phenotype data based on a weight value corresponding to each first to-be-fused crop phenotype datum and the intrinsic and extrinsic parameter data of the crop phenotype sensors that collects the various to-be-fused crop phenotype data, so as to obtain fused data corresponding to the various to-be-fused crop phenotype data.

Specifically, after acquiring the weight value corresponding to each first to-be-fused crop phenotype datum, data fusion is performed on the various to-be-fused crop phenotype data by means of numerical calculation, mathematical statistics and deep learning technology based on the weight value corresponding to each first to-be-fused crop phenotype data and the intrinsic and extrinsic parameter data of the crop phenotype sensor that collects each to-be-fused crop phenotype data, so as to obtain the fused data corresponding to various to-be-fused crop phenotype data.

In step 105, the fused data of the target crop is input into a trained estimation model to output a characteristic indicator of the target crop, wherein the trained estimation model is obtained by training a neural network model based on sample fused data and a corresponding characteristic indicator.

As an optional embodiment, the data fusion is performed on the various to-be-fused crop phenotype data based on the weight value corresponding to each first to-be-fused crop phenotype datum and the intrinsic and extrinsic parameter data of the crop phenotype sensors that collects the various to-be-fused crop phenotype data, so as to obtain the fused data corresponding to the various to-be-fused crop phenotype data, which includes: denoising each to-be-fused crop phenotype datum to acquire a denoised to-be-fused crop phenotype datum.

Specifically, in the embodiment of the present disclosure, each to-be-fused crop phenotype data is denoised to acquire the denoised to-be-fused crop phenotype datum by means of wavelet denoising, Kalman filtering, etc.

Initial alignment is performed on the denoised to-be-fused crop phenotype datum based on the intrinsic and extrinsic parameter data of a crop phenotype sensor that collects the to-be-fused crop phenotype datum, so as to acquire a to-be-fused crop phenotype datum after initial alignment.

Specifically, after acquiring the denoised to-be-fused crop phenotype datum, initial alignment is performed on each denoised to-be-fused crop phenotype datum based on the intrinsic and extrinsic parameter data of the crop phenotype sensor that collects the to-be-fused crop phenotype datum using a synchronous multi-view geometric correction method, so that each denoised to-be-fused crop phenotype datum is aligned in the time and space dimensions, so as to acquire the to-be-fused crop phenotype datum after initial alignment is acquired.

The specific alignment method includes: using the Levenberg-Marquardt optimization algorithm and the extrinsic parameter self-calibration algorithm to align the denoised to-be-fused crop phenotype data in the time and space dimensions.

Data fusion is performed on all first to-be-fused crop phenotype data after initial alignment based on weight values corresponding to all first to-be-fused crop phenotype data, so as to acquire the first fused data.

Specifically, after acquiring all to-be-fused crop phenotype data after initial alignment, data fusion is performed on all to-be-fused crop phenotype data after initial alignment based on the weight values corresponding to all first to-be-fused crop phenotype data by numerical calculation, so as to acquire the first fused data.

As an optional embodiment, data fusion is performed on all first to-be-fused crop phenotype data after initial alignment based on weight values corresponding to all first to-be-fused crop phenotype data, so as to acquire the first fused data, which includes: performing data fusion on the first to-be-fused crop phenotype data after initial alignment using an iterative closest point algorithm based on the weight values corresponding to the first to-be-fused crop phenotype data, so as to acquire the first fused data.

It should be noted that the Iterative Closest Point (ICP) algorithm is an iterative calculation method, which is mainly used for accurate stitching of depth images in computer vision and for point cloud matching (rigid registration). The ICP algorithm minimizes the distance between the corresponding points of source data and target data through continuous iteration to achieve accurate stitching or registration.

In the embodiment of the present disclosure, when data fusion is performed on all first to-be-fused crop phenotype data after initial alignment using an iterative closest point algorithm based on the weight values corresponding to the first to-be-fused crop phenotype data, the minimum error E between the j-th first to-be-fused crop phenotype data and the first to-be-fused crop phenotype data closest to the j-th first to-be-fused crop phenotype data is calculated according to the weight value corresponding to each first to-be-fused crop phenotype data. The specific calculation formula is as follows:

$$E = {\sum }_{j = 1}^{n} {W}_{j} \cdot {‖ {p}_{j} - {q}_{j} ‖}^{2} ,$$

where n denotes the total number of each first to-be-fused crop phenotype data; Wⱼ denotes a weight value corresponding to the j-th first to-be-fused crop phenotype data; pⱼ denotes the j-th first to-be-fused crop phenotype data; qⱼ denotes the first to-be-fused crop phenotype data closest to the j-th first to-be-fused crop phenotype data.

In each iterative calculation, the position and orientation (a rotation matrix and a displacement vector) of the first to-be-fused crop phenotype data is adjusted to minimize the weighted error function and ensure the accurate alignment of each first to-be-fused crop phenotype data.

Through the above algorithm, the precision of data fusion performed on the first to-be-fused crop phenotype data can be maximized, and the first fused data obtained by data fusion can be ensured to have higher spatial consistency and feature expression ability.

According to the embodiment of the present disclosure, not only all to-be-fused crop phenotype data is aligned in space through least square optimization, but also data fusion is performed on all first to-be-fused crop phenotype data after initial alignment using an iterative closest point algorithm based on the weight value corresponding to each first to-be-fused crop phenotype data, and the first fused data is obtained, so that the fusion precision of the first to-be-fused crop phenotype data can be improved, thereby the data fusion precision and the data fusion effect of the data fusion method provided by the present disclosure can be further improved.

Data fusion is performed on all second to-be-fused crop phenotype data after initial alignment and the first fused data, so as to obtain the fused data, where the second to-be-fused crop phenotype data is crop phenotype data except the first to-be-fused crop phenotype data in various to-be-fused crop phenotype data.

Specifically, after acquiring the first fused data, data fusion is performed on all second to-be-fused crop phenotype data after initial alignment and the first fused data by means of deep learning technology, numerical calculation and mathematical statistics, so as to obtain and the fused data of various to-be-fused crop phenotype data.

As an optional embodiment, data fusion is performed on second to-be-fused crop phenotype data after initial alignment and the first fused data, so as to obtain the fused data, where the second to-be-fused crop phenotype data is crop phenotype data except the first to-be-fused crop phenotype data in various to-be-fused crop phenotype data, includes: extracting features of the second to-be-fused crop phenotype data after initial alignment, so as to acquire feature information corresponding to the second to-be-fused crop phenotype data after initial alignment.

Specifically, in the embodiment of the present disclosure, a multi-scale convolution kernel of a Convolutional Neural Network (CNN) can be used to extract the feature information of different scales in each second to-be-fused crop phenotype data. Through feature extraction at different scales, the effective fusion of high-resolution data and low-resolution data can be ensured, and the feature expression of the fused data can be enhanced.

The feature information corresponding to the second to-be-fused crop phenotype data after initial alignment is mapped into the first fused data, so as to obtain fused data.

Specifically, in the embodiment of the present disclosure, a deep learning network based on spatial-temporal consistency is used to map feature information corresponding to the second to-be-fused crop phenotype data after initial alignment into the first fused data, so as to realize the deep fusion of the feature information corresponding to the second to-be-fused crop phenotype data with the first fused data.

The deep learning network based on spatial-temporal consistency includes a spatial-temporal consistency calibration module and a multi-level feature enhancement module.

The spatial-temporal consistency calibration module processes each second to-be-fused crop phenotype data by using a Recurrent Neural Network (RNN) to ensure the consistency of all second to-be-fused crop phenotype data in the time dimension.

The data mapping module maps feature information corresponding to the second to-be-fused crop phenotype data after initial alignment into the first fused data through the spatial position correspondence between the first fused data and the feature information corresponding to the second crop phenotype data, and the original fused data is acquired.

Specifically, for example, in an embodiment, by using the camera's intrinsic and extrinsic parameters, the first fused point cloud is projected onto each 2D image plane and the RGB, temperature, and reflectance channels are sampled. Vegetation indices (e.g., NDVI, NDRE, PRI), along with textural and morphological features, are computed. These pixel-level features are then back-projected and assigned as per-point attributes to the point cloud or mesh, resulting in a multi-attribute data structure: {x, y, z, n, R, G, B, T, NDVI, NDRE, PRI, w_i, t, . . . }. If a topological representation is required, Poisson reconstruction or spherical neighborhood triangulation is employed to generate an attributed mesh.

The multi-level feature enhancement module performs feature enhancement processing on the original fused data obtained after fusion through the deep convolution network, extracts more detailed crop features, and further improves the weight of key features through an attention mechanism, thereby obtaining the fused data.

It should be noted that after acquiring the fused data of various to-be-fused crop phenotype data, the fused data can be stored in a standardized adaptive data structure, and the structure of any data point in the fused data can include: XYZRGBSIS2S3S4T1T2WsEm1Em2TimeType1 . . . .

Where XYZ denotes the three-dimensional spatial position of the data point. RGB denotes the color information acquired by the visible light image sensors. S1-S4 denotes the multi-spectral reflectivity of different bands. T1 denotes the thermal imaging temperature data. T2 denotes the environmental temperature. Ws denotes the ambient wind speed. Em1-Em2 denotes the sensor exposure time. Time is the collection time stamp. Type1 denotes semantic annotation (such as the plant type).

According to the embodiment of the present disclosure, all the target data corresponding to the first to-be-fused crop phenotype data is input into a weight adjustment model. After a weight value corresponding to each first to-be-fused crop phenotype datum output by the weight adjustment model is acquired, data fusion is performed on the plurality of to-be-fused crop phenotype data based on the weight value corresponding to each first to-be-fused crop phenotype data and intrinsic and extrinsic parameter data of the crop phenotype sensors that collect the plurality of to-be-fused crop phenotype data, so as to obtain fused data corresponding to the plurality of to-be-fused crop phenotype data. The data quality of the sample crop phenotype data, the relative position relationship between the sample crop phenotype sensor when collecting the sample crop phenotype data and the sample crop, the environmental factors in which the sample crop phenotype sensor collects the sample crop phenotype data, and the influence of the growth stages of the sample crop on the sample crop phenotype data, can be taken into account comprehensively. The weight value corresponding to the sample crop phenotype data can be acquired more accurately, so that the weight value corresponding to each to-be-fused crop phenotype data can be acquired more efficiently and accurately through deep learning. The fusion efficiency and the fusion effect of crop phenotype data fusion can be improved. A more accurate data basis can be provided for high-precision three-dimensional modeling, crop feature extraction and other application scenes of precision agriculture, which has broad application prospects.

According to the crop phenotype data fusion method provided by the present disclosure, the contribution degrees of different data sources change in real time according to the actual situation through an adaptive weight adjustment method, so that the flexibility and the precision of data fusion are improved. The machine learning algorithm is combined with the self-learning mechanism, which can quickly adjust the fusion strategy, greatly reduce the data processing time, and adapt to the application requirement of the high-timeliness crop phenotype. The fusion of multi-dimensional data, especially the synchronous processing of spatial-temporal data, significantly improves the overall relevance and the analysis precision of data.

Furthermore, the fused data can be further applied to various applications, such as crop growth prediction and growth model calibration, disease identification and spread tracking, light efficiency and water-fertilizer utilization optimization, and intelligent multidimensional meteorological emergency strategies.

In some embodiments, the fused data can be used for fine-grained crop growth prediction and growth model calibration. By integrating environmental dimension data (e.g., temperature, humidity, light intensity) and imaging data (e.g., spectral imaging), physiological indicators such as photosynthetic efficiency and transpiration rate can be precisely analyzed. These indicators can be correlated with concrete data (e.g., leaf area index, plant height) to establish refined prediction models for crop growth. Based on such models, the system can generate forecasts in response to real-time meteorological changes and provide farmers with dynamic cultivation recommendations (e.g., transplanting, density adjustment, or thinning) to maximize crop growth potential. Traditional methods relying on isolated environmental or imaging data struggle to achieve high-precision growth models, whereas data fusion enables dynamic updates of predictions and continuous optimization of model accuracy.

Specifically, the present disclosure can integrate with established model such as LSTM, Random Forest, XGBoost, and Convolutional Neural Networks across multiple application scenarios including crop growth prediction, growth model calibration, disease identification, and water/fertilizer utilization optimization. Targeted improvements are implemented in input feature design, model structure adaptation, and fused data preprocessing.

For example, in crop growth prediction applications, an LSTM-based time-series prediction model is adopted. The model inputs fused multidimensional feature sequences comprising environmental data (temperature, humidity, light intensity), imaging features (NDVI, thermal imaging anomalies), and 3D morphological characteristics (plant height, canopy width). Through regression calibration with ground-measured growth indicators, the model outputs predicted metrics such as leaf area index, biomass, or growth stage classification. Compared with traditional single-dimension modeling methods, this model achieves higher prediction accuracy and adaptability.

Thus, while the model of the present disclosure builds upon existing technical models, its core innovations lie in three key aspects: the multidimensional fused data structure design; spatiotemporal synchronization mechanisms; and optimized model input feature composition. These advancements collectively enable joint modeling across diverse data dimensions while enhancing both practical utility and response speed, representing significant technological progress.

In some embodiments, the fused data can be used for real-time disease identification and spread tracking. Early disease detection using single imaging data often fails to distinguish pathological changes from normal physiological variations. However, by fusing imaging dimension data (RGB, thermal imaging) and environmental dimension data (e.g., air humidity, soil temperature), risk factors (such as the heat stress risk index, the water stress risk index, the disease risk index, and the lodging risk index) and transmission pathways of diseases can be identified. For example, analyzing correlations between temperature anomalies in diseased leaves and humidity levels allows earlier detection of potential causes and trends. Historical spatiotemporal diffusion data can further enable dynamic modeling to visualize disease spread trajectories. Traditional methods lack the capability to rapidly identify spatiotemporal characteristics of disease propagation, while fused spatiotemporal and environmental data enhance precision and enable real-time control.

In the domains of early disease identification and transmission pathway modeling, the following modeling approaches may be employed. For disease risk identification models, Convolutional Neural Networks (CNN) may process RGB and thermal imaging data for feature extraction, while Multilayer Perceptron (MLP) handles environmental parameters (e.g., ambient humidity, soil temperature). A fusion layer subsequently integrates imaging features with environmental characteristics for joint modeling. This architecture outputs disease risk levels and/or determines whether to issue alerts. Regarding disease transmission path modeling, Spatio-Temporal Graph Neural Networks (ST-GNN) or Dynamic Bayesian Networks (DBN) may be utilized. Plant spatial positions serve as graph nodes, incorporating historical time-series imaging data and environmental parameters to construct spatiotemporal graphs. Node state evolution predicts disease propagation paths while generating visual trajectories. Temperature and humidity anomaly detection may employ K-means or density-based clustering algorithms (e.g., Density-Based Spatial Clustering of Applications with Noise (DBSCAN)). These methods jointly cluster thermal imaging leaf temperature distribution maps with localized humidity data to identify early-stage thermal anomalies. Cross-referencing with historical data enables determination of potential disease trends. The aforementioned models may be implemented using existing open-source frameworks such as TensorFlow or PyTorch.

In some embodiments, the fused data can be used for multidimensional optimization of light efficiency and water-fertilizer utilization. Data fusion enables real-time monitoring of photosynthetic efficiency and resource utilization (such as water-fertilizer utilization rates) across crop growth stages. For instance, combining RGB and spectral imaging data allows real-time tracking of light reflectance and nitrogen content in leaves. Simultaneously, environmental data such as soil moisture, air humidity, and wind speed enable the system to calculate and predict water-fertilizer absorption efficiency. The term “fused data” primarily refers to, but is not limited to, imaging data dimensions (e.g., RGB, spectral reflectance information) and environmental data dimensions (e.g., soil moisture, air humidity, wind speed). After fusion processing, this data forms a unified feature input that can be used to build predictive models or rule engines, thereby enabling estimation and dynamic adjustment of water-nutrient absorption efficiency. This fused monitoring system significantly improves precision in resource management, dynamically adjusting inputs based on real-time plant needs to maximize utilization. Such granular dynamic management is unachievable without multisource data fusion.

In practical implementations, the system does not always require all fused data dimensions. Instead, it selects specific dimensions for modeling and analysis based on the task. For instance, in irrigation control scenarios, fusing only environmental data (e.g., soil moisture, air temperature, wind speed) may suffice for estimating water use efficiency. For another instance, in crop nutrition monitoring scenarios, the fusion may focus on imaging data (e.g., near-infrared reflectance or normalized difference vegetation index (NDVI), etc.) combined with select environmental data. Thus, the fusion mechanism provided by the present disclosure offers high flexibility and configurability, dynamically adapting the adopted data dimensions according to target objectives.

In some embodiments, the fused data can support intelligent multidimensional meteorological emergency strategies. Under extreme weather conditions, data fusion provides actionable crop protection strategies. For example, by integrating real-time imaging, point cloud data, and environmental data, the system can assess crop resilience during extreme wind or temperature events. In typhoon scenarios, fused wind speed, humidity (environmental dimension), 3D morphology (concrete dimension), and crop growth dynamics (spatiotemporal dimension) can predict damage locations and scales, enabling preemptive measures like structural reinforcement or wind barriers. Traditional single-source systems offer fragmented insights, while fused data delivers holistic disaster resilience assessments and targeted emergency responses.

In some embodiments, the fused data can advance biodiversity conservation and crop gene screening. In breeding research, data fusion accelerates gene selection by analyzing crop performance under specific climatic conditions. For example, combining environmental data, imaging data, and 3D morphology data reveals growth patterns and stress resistance across crop varieties. Spatiotemporal fusion data further tracks temporal trends in gene expression, aiding the selection of resilient and adaptive cultivars. Data fusion consolidates multi-trait comparisons on a unified platform, enabling precise multigene trait mining and genetic improvement-a capability unattainable with traditional methods that struggle to correlate environmental and multidimensional phenotypic data.

Compared to non-fused data approaches, the fused solutions offer the following advantages:
(1) Data fusion technology automatically integrates, correlates, and analyzes multisource data, outperforming manual processing. For example, during sudden disease outbreaks or extreme weather, the system can fuse environmental, imaging, and 3D morphological data within seconds to predict disease spread or wind damage zones, enabling rapid emergency responses. Manual analysis cannot match this speed, risking missed intervention opportunities.
(2) Beyond simple data combination, fusion methods uncover hidden relationships to automate complex pattern mining. For instance, historical spatiotemporal fusion data can autonomously identify crop-specific physiological patterns under specific environmental conditions—patterns easily overlooked in manual analysis. Early disease symptoms, such as subtle spectral, thermal, or morphological changes, can trigger automated alerts, whereas manual analysis often fails to detect such nuances.
(3) Fusion enables joint modeling of multidimensional features by generating high-dimensional composite metrics. For example, integrating spectral imaging (imaging dimension), leaf area index (3D dimension), and humidity (environmental dimension) produces a unified “light efficiency-humidity-morphology” indicator to precisely reflect crop growth. Manual metric combination requires separate calculations and risks overlooking nonlinear relationships, reducing accuracy.
(4) Data fusion provides an automated workflow from data collection to analysis, minimizing human intervention. New data is dynamically incorporated into models to update results. In contrast, manual methods require repetitive reprocessing, especially inefficient in large-scale scenarios.
(5) Fusion automatically links data across time and space. For example, it tracks disease progression from early to mature stages or generates growth models to predict regional crop performance. Manual analysis struggles to efficiently manage or correlate vast spatiotemporal datasets, leading to outdated or inaccurate predictions.
(6) Automated fusion ensures algorithm-driven, consistent results, critical for high-stakes applications like breeding and disease monitoring. Manual analysis, influenced by subjective judgment, lacks such reliability.

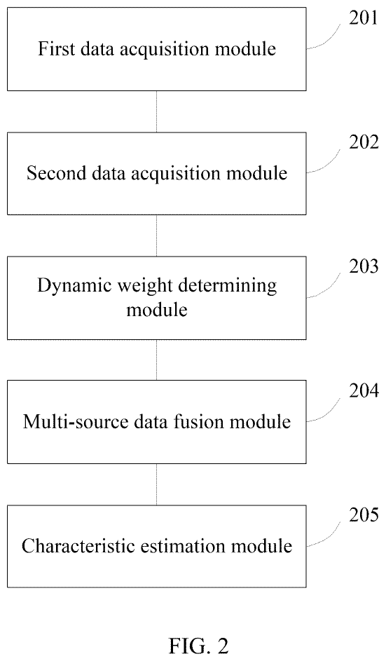

FIG. 2 is a schematic structural diagram of a crop phenotype data fusion apparatus according to the present disclosure. The crop phenotype data fusion apparatus according to the present disclosure will be described with reference to FIG. 2 hereinafter. The crop phenotype data fusion apparatus described hereinafter and the crop phenotype data fusion method according to the present disclosure described above can be referred to each other. As shown in FIG. 2, the apparatus includes a first data acquisition module 201, a second data acquisition module 202, a dynamic weight determining module 203, a multi-source data fusion module 204 and a characteristic estimation module 205.

The first data acquisition module 201 is configured to acquire a plurality of to-be-fused crop phenotype data, where the plurality of to-be-fused crop phenotype data includes crop phenotype data of a target crop and/or crop phenotype data of the target crop in a plurality of growth stages, collected by different types of crop phenotype sensors.

The second data acquisition module 202 is configured to acquire intrinsic and extrinsic parameter data of the crop phenotype sensors when collecting each to-be-fused crop phenotype data as well as target data corresponding to first to-be-fused crop phenotype data, where the first to-be-fused crop phenotype data is three-dimensional data from the plurality of to-be-fused crop phenotype data, the target data includes environmental data when collecting the crop phenotype data, relative position information between the crop phenotype sensors that collect the crop phenotype data and a crop, and a target parameter value of the crop phenotype data, and the target parameter values include a signal-to-noise ratios and/or feature entropies.

The dynamic weight determining module 203 is configured to input all the target data corresponding to the first to-be-fused crop phenotype data into a weight adjustment model, and acquire a weight value corresponding to each first to-be-fused crop phenotype datum output by the weight adjustment model, where the weight adjustment model is obtained by training based on a target datum corresponding to each sample crop phenotype datum in a sample data set and a weight value corresponding to each sample crop phenotype datum, and the sample crop phenotype data includes crop phenotype data of a sample crop collected by the different types of crop phenotype sensors and crop phenotype data of the sample crop in the plurality of growth stages.

The multi-source data fusion module 204 is configured to perform data fusion on the plurality of to-be-fused crop phenotype data based on a weight value corresponding to each first to-be-fused crop phenotype datum and intrinsic and extrinsic parameter data of the crop phenotype sensors that collect the plurality of to-be-fused crop phenotype data, so as to obtain fused data corresponding to the plurality of to-be-fused crop phenotype data.

The characteristic estimation module 205 is configured to input the fused data of the target crop into a trained estimation model to output a characteristic indicator of the target crop.

Specifically, the first data acquisition module 201, the second data acquisition module 202, the dynamic weight determining module 203, the multi-source data fusion module 204 and the characteristic estimation module 205 are electrically connected.

According to the crop phenotype data fusion apparatus in the embodiment of the present disclosure, all the target data corresponding to the first to-be-fused crop phenotype data are input into a weight adjustment model. After a weight value corresponding to each first to-be-fused crop phenotype datum output by the weight adjustment model is acquired, data fusion is performed on the plurality of to-be-fused crop phenotype data based on a weight value corresponding to each first to-be-fused crop phenotype data and intrinsic and extrinsic parameter data of the crop phenotype sensors that collect the plurality of to-be-fused crop phenotype data, so as to obtain fused data corresponding to the plurality of to-be-fused crop phenotype data. The data quality of the sample crop phenotype data, the relative position relationship between the sample crop phenotype sensor when collecting the sample crop phenotype data and the sample crop, the environmental factors in which the sample crop phenotype sensor collects the sample crop phenotype data, and the influence of the growth stages of the sample crop on the sample crop phenotype data, can be taken into account comprehensively. The weight value corresponding to the sample crop phenotype data can be acquired more accurately, so that the weight value corresponding to each to-be-fused crop phenotype data can be acquired more efficiently and accurately through deep learning. The fusion efficiency and the fusion effect of crop phenotype data fusion can be improved. A more accurate data basis can be provided for high-precision three-dimensional modeling, crop feature extraction and other application scenes of precision agriculture, which has broad application prospects.

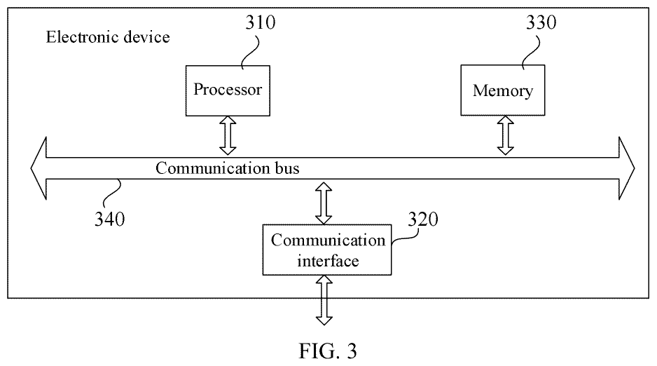

FIG. 3 illustrates a schematic diagram of a physical structure of an electronic device. As shown in FIG. 3, the electronic device may include a processor 310, a communication interface 320, a memory 330 and a communication bus 340, where the processor 310, the communication interface 320 and the memory 330 communicate with each other through the communication bus 340. The processor 310 can call the logic instructions in the memory 330 to execute the crop phenotype data fusion method. The method includes: acquiring a plurality of to-be-fused crop phenotype data, where the plurality of to-be-fused crop phenotype data includes crop phenotype data of a target crop and/or crop phenotype data of the target crop in a plurality of growth stages, collected by different types of crop phenotype sensors; acquiring intrinsic and extrinsic parameter data of the crop phenotype sensors when collecting the plurality of to-be-fused crop phenotype data, as well as target data corresponding to first to-be-fused crop phenotype data, where the first to-be-fused crop phenotype data is three-dimensional data from the plurality of to-be-fused crop phenotype data, the target data includes environmental data when collecting the crop phenotype data, relative position information between the crop phenotype sensors that collect the crop phenotype data and a crop, and target parameter values of the crop phenotype data, and the target parameter values include signal-to-noise ratios and/or feature entropies; inputting all the target data corresponding to the first to-be-fused crop phenotype data into a weight adjustment model, and acquiring a weight value corresponding to each first to-be-fused crop phenotype datum output by the weight adjustment model, where the weight adjustment model is obtained by training based on a target datum corresponding to each sample crop phenotype datum in a sample data set and a weight value corresponding to each sample crop phenotype datum, and sample crop phenotype data includes crop phenotype data of a sample crop collected by the different types of crop phenotype sensors and crop phenotype data of the sample crop in the plurality of growth stages; and performing data fusion on the plurality of to-be-fused crop phenotype data based on a weight value corresponding to each first to-be-fused crop phenotype datum and the intrinsic and extrinsic parameter data of the crop phenotype sensors that collects the plurality of to-be-fused crop phenotype data, so as to obtain fused data corresponding to the plurality of to-be-fused crop phenotype data.

In addition, the above-mentioned logical instructions in the memory 330 can be implemented in the form of software functional units and can be stored in a computer-readable storage medium when the logical instructions are sold or used as independent products. Based on this understanding, the essence of the technical solution of the present disclosure, or the part that contributes to the prior art, or the part of the technical solution can be embodied in the form of a software product. The computer software product is stored in a storage medium and includes several instructions to cause a computer device (which can be a personal computer, a server, a network device, etc.) to execute all or part of the steps of the method described in various embodiments of the present disclosure. The aforementioned storage medium includes: a USB flash drive, a mobile hard disk, a Read-Only Memory (ROM), a Random Access Memory (RAM), a magnetic disk or an optical disk and other media that can store program codes.

On the other hand, the present disclosure further provides a computer program product, which includes a computer program, where the computer program can be stored on a non-transient computer-readable storage medium, and when the computer program is executed by a processor, the computer can implement the crop phenotype data fusion method provided by the above methods. The method includes: acquiring a plurality of to-be-fused crop phenotype data, where the plurality of to-be-fused crop phenotype data includes crop phenotype data of a target crop and/or crop phenotype data of the target crop in a plurality of growth stages, collected by different types of crop phenotype sensors; acquiring intrinsic and extrinsic parameter data of the crop phenotype sensors when collecting the plurality of to-be-fused crop phenotype data, as well as target data corresponding to first to-be-fused crop phenotype data, where the first to-be-fused crop phenotype data is three-dimensional data from the plurality of to-be-fused crop phenotype data, the target data includes environmental data when collecting the crop phenotype data, relative position information between the crop phenotype sensors that collect the crop phenotype data and a crop, and target parameter values of the crop phenotype data, and the target parameter values include signal-to-noise ratios and/or feature entropies; inputting all the target data corresponding to the first to-be-fused crop phenotype data into a weight adjustment model, and acquiring a weight value corresponding to each first to-be-fused crop phenotype datum output by the weight adjustment model, where the weight adjustment model is obtained by training based on a target datum corresponding to each sample crop phenotype datum in a sample data set and a weight value corresponding to each sample crop phenotype datum, and sample crop phenotype data includes crop phenotype data of a sample crop collected by the different types of crop phenotype sensors and crop phenotype data of the sample crop in the plurality of growth stages; and performing data fusion on the plurality of to-be-fused crop phenotype data based on a weight value corresponding to each first to-be-fused crop phenotype datum and the intrinsic and extrinsic parameter data of the crop phenotype sensors that collects the plurality of to-be-fused crop phenotype data, and obtaining fused data corresponding to various to-be-fused crop phenotype data.

On the other hand, the present disclosure further provides a non-transient computer-readable storage medium on which a computer program is stored, where the computer program, when executed by a processor, implements the crop phenotype data fusion method provided by the above methods. The method includes: acquiring a plurality of to-be-fused crop phenotype data, where the plurality of to-be-fused crop phenotype data includes crop phenotype data of a target crop and/or crop phenotype data of the target crop in a plurality of growth stages, collected by different types of crop phenotype sensors; acquiring intrinsic and extrinsic parameter data of the crop phenotype sensors when collecting the plurality of to-be-fused crop phenotype data, as well as target data corresponding to first to-be-fused crop phenotype data, where the first to-be-fused crop phenotype data is three-dimensional data from the plurality of to-be-fused crop phenotype data, the target data includes environmental data when collecting the crop phenotype data, relative position information between the crop phenotype sensors that collect the crop phenotype data and a crop, and target parameter values of the crop phenotype data, and the target parameter values include signal-to-noise ratios and/or feature entropies; inputting all the target data corresponding to the first to-be-fused crop phenotype data into a weight adjustment model, and acquiring a weight value corresponding to each first to-be-fused crop phenotype datum output by the weight adjustment model, where the weight adjustment model is obtained by training based on a target datum corresponding to each sample crop phenotype datum in a sample data set and a weight value corresponding to each sample crop phenotype datum, and sample crop phenotype data includes crop phenotype data of a sample crop collected by the different types of crop phenotype sensors and crop phenotype data of the sample crop in the plurality of growth stages; and performing data fusion on the plurality of to-be-fused crop phenotype data based on a weight value corresponding to each first to-be-fused crop phenotype datum and the intrinsic and extrinsic parameter data of the crop phenotype sensors that collects the plurality of to-be-fused crop phenotype data, so as to obtain fused data corresponding to the plurality of to-be-fused crop phenotype data.

The apparatus embodiments described above are only schematic, in which the units described as separate components may or may not be physically separated. The components displayed as units may or may not be physical units, that is, the components may be located in one place or distributed to a plurality of network units. Some or all of the modules can be selected according to actual needs to achieve the purpose of this embodiment. Those skilled in the art can understand and implement the purpose without paying creative labor.

From the description of the above embodiments, those skilled in the art can clearly understand that each embodiment can be realized by means of software plus necessary general hardware platforms, and of course, can also be realized by hardware. Based on this understanding, the essence of the above technical solution or the part that contributes to the prior art can be embodied in the form of a software product. The computer software product can be stored in a computer-readable storage medium, such as an ROM/RAM, a magnetic disk, an optical disk, etc., and includes several instructions to cause a computer device (which can be a personal computer, a server, a network device, etc.) to execute the methods described in various embodiments or some parts of the embodiments.

Finally, it should be explained that the above embodiments are only used to illustrate the technical solution of the present disclosure, rather than limit the technical solution. Although the present disclosure has been described in detail with reference to the foregoing embodiments, those skilled in the art should understand that it is still possible to modify the technical solution described in the foregoing embodiments, or to replace some technical features with equivalents. However, these modifications or replacements do not make the essence of the corresponding technical solutions deviate from the spirit and scope of the technical solutions of various embodiments of the present disclosure.

What is claimed is:

1. A crop phenotype data fusion method, comprising:
acquiring a plurality of to-be-fused crop phenotype data, wherein the plurality of to-be-fused crop phenotype data comprises one or more of crop phenotype data of a target crop and crop phenotype data of the target crop in a plurality of growth stages, collected by different types of crop phenotype sensors;
acquiring intrinsic and extrinsic parameter data of crop phenotype sensors when collecting the plurality of to-be-fused crop phenotype data, as well as target data corresponding to first to-be-fused crop phenotype data, wherein the first to-be-fused crop phenotype data is three-dimensional data from the plurality of to-be-fused crop phenotype data, the target data comprises environmental data when collecting the crop phenotype data, relative position information between the crop phenotype sensors that collect the crop phenotype data and a crop, and target parameter values of the crop phenotype data, and the target parameter values comprise signal-to-noise ratios and/or feature entropies;
inputting all the target data corresponding to the first to-be-fused crop phenotype data into a weight adjustment model, and acquiring a weight value corresponding to each first to-be-fused crop phenotype datum output by the weight adjustment model, wherein the weight adjustment model is obtained by training based on a target datum corresponding to each sample crop phenotype datum in a sample data set and a weight value corresponding to each sample crop phenotype datum, and sample crop phenotype data comprises crop phenotype data of a sample crop collected by the different types of crop phenotype sensors and crop phenotype data of the sample crop in the plurality of growth stages;
performing data fusion on the plurality of to-be-fused crop phenotype data based on a weight value corresponding to each first to-be-fused crop phenotype datum and the intrinsic and extrinsic parameter data of the crop phenotype sensors that collects the plurality of to-be-fused crop phenotype data, to obtain fused data corresponding to the plurality of to-be-fused crop phenotype data, and
inputting the fused data of the target crop into a trained estimation model to output a characteristic indicator of the target crop, wherein the trained estimation model is obtained by training a neural network model based on sample fused data and a corresponding characteristic indicator.

2. The crop phenotype data fusion method according to claim 1, wherein the crop phenotype sensors comprise one or more of a laser radar sensor, a depth image sensor, a multispectral image sensor, a visible light image sensor, and an infrared thermal imaging sensor, wherein the laser radar sensor and the depth image sensor are configured to collect the first to-be-fused crop phenotype data which comprises three-dimensional imaging information, and the multispectral image sensor, the visible light image sensor, and the infrared thermal imaging sensor are configured to collect second to-be-fused crop phenotype data which comprises two-dimensional imaging information, wherein the second to-be-fused crop phenotype data is crop phenotype data except the first to-be-fused crop phenotype data in the plurality of to-be-fused crop phenotype data; and
wherein the fused data comprises environmental information of the target crop, spatiotemporal information, and one or more of the two-dimensional imaging information and the three-dimensional imaging information of the target crop.

3. The crop phenotype data fusion method according to claim 1, wherein the crop phenotype sensors comprise a multispectral image sensor, and the fused data comprises two-dimensional imaging information, environmental information that comprises air temperature and soil moisture, and spatiotemporal information, and
wherein based on the fused data, the trained estimation model outputs a water stress risk index (WSI), and wherein the crop phenotype data fusion method further comprises: when the WSI is higher than a predetermined threshold, sending a signal to an existing irrigation system to instruct the existing irrigation system performing irrigation.

4. The crop phenotype data fusion method according to claim 1, wherein the crop phenotype sensors comprise an infrared thermal imaging sensor and a visible light image sensor, and the fused data comprises two-dimensional imaging information that comprises RGB imaging data and thermal imaging data, environmental information that comprises air temperature and soil moisture, and spatiotemporal information, and
wherein based on the fused data, the trained estimation model outputs a disease risk index (DRI), and wherein the crop phenotype data fusion method further comprises: when the DRI is higher than a predetermined threshold, sending a signal to an existing aerial spraying system to instruct the existing aerial spraying system performing spraying.

5. The crop phenotype data fusion method according to claim 1, wherein the weight value corresponding to each sample crop phenotype datum is acquired based on following steps:
acquiring a first weight score corresponding to each sample crop phenotype datum based on a target parameter value of the sample crop phenotype datum, acquiring a second weight score corresponding to the sample crop phenotype datum based on the relative position information between a sample crop phenotype sensor that collects the sample crop phenotype datum and the sample crop, acquiring a third weight score corresponding to the sample crop phenotype datum based on environmental data when collecting the sample crop phenotype datum and a type of the sample crop phenotype sensor, and acquiring a fourth weight score corresponding to the sample crop phenotype datum based on a growth stage of the sample crop when collecting the sample crop phenotype datum and the type of the sample crop phenotype sensor; and
calculating the weight value corresponding to the sample crop phenotype datum based on the first weight score, the second weight score, the third weight score and the fourth weight score corresponding to the sample crop phenotype datum.

6. The crop phenotype data fusion method according to claim 1, wherein the performing the data fusion on the plurality of to-be-fused crop phenotype data based on the weight value corresponding to each first to-be-fused crop phenotype datum and the intrinsic and extrinsic parameter data of the crop phenotype sensors that collect the plurality of to-be-fused crop phenotype data, to obtain the fused data corresponding to the plurality of to-be-fused crop phenotype data, comprises:
denoising each to-be-fused crop phenotype datum to acquire a denoised to-be-fused crop phenotype datum;
performing initial alignment on the denoised to-be-fused crop phenotype datum based on intrinsic and extrinsic parameter data of a crop phenotype sensor that collects the to-be-fused crop phenotype datum, to acquire a to-be-fused crop phenotype datum after initial alignment;
performing data fusion on all first to-be-fused crop phenotype data after initial alignment based on weight values corresponding to all first to-be-fused crop phenotype data, to acquire first fused data; and
performing data fusion on all second to-be-fused crop phenotype data after initial alignment and the first fused data, to obtain the fused data, wherein the second to-be-fused crop phenotype data is crop phenotype data except the first to-be-fused crop phenotype data in the plurality of to-be-fused crop phenotype data.

7. The crop phenotype data fusion method according to claim 5, wherein the acquiring the first weight score corresponding to each sample crop phenotype datum based on the target parameter value of the sample crop phenotype datum, comprises:
determining the target parameter value of the sample crop phenotype datum as an independent variable, determining the first weight score corresponding to the sample crop phenotype datum as a dependent variable, and calculating the first weight score corresponding to the sample crop phenotype datum based on the target parameter value of the sample crop phenotype datum and a positive correlation function, wherein the positive correlation function is configured for describing a positive correlation relationship between the independent variable and the dependent variable;
wherein the acquiring the second weight score corresponding to the sample crop phenotype datum based on the relative position information between the sample crop phenotype sensor that collects the sample crop phenotype datum and the sample crop comprises:
acquiring a distance between the sample crop phenotype sensor and the sample crop and a vertical distance between the sample crop and a target reference line based on the relative position information between the sample crop phenotype sensor and the sample crop, wherein the target reference line is a central axis of a field of view of the sample crop phenotype sensor;
determining the distance as an independent variable, determining a first sub-weight score corresponding to the sample crop phenotype datum as a dependent variable, calculating the first sub-weight score corresponding to the sample crop phenotype datum based on the distance and the positive correlation function, determining the vertical distance as an independent variable, determining a second sub-weight score corresponding to the sample crop phenotype datum as a dependent variable, and calculating the second sub-weight score corresponding to the sample crop phenotype datum based on the distance and a negative correlation function; and
calculating the second weight score corresponding to the sample crop phenotype datum based on the first sub-weight score and the second sub-weight score corresponding to the sample crop phenotype datum;
wherein the acquiring the third weight score corresponding to the sample crop phenotype datum based on the environmental data when collecting the sample crop phenotype datum and the type of the sample crop phenotype sensor comprises:
acquiring a first matching degree between environmental data when collecting the sample crop phenotype datum and the type of the sample crop phenotype sensor; and
determining the first matching degree as an independent variable, determining the third weight score corresponding to the sample crop phenotype datum as a dependent variable, and calculating the third weight score corresponding to the sample crop phenotype datum based on the first matching degree and the positive correlation function;
wherein the acquiring the fourth weight score corresponding to the sample crop phenotype datum based on the growth stage of the sample crop when collecting the sample crop phenotype datum and the type of the sample crop phenotype sensor comprises:
acquiring a second matching degree between the growth stage of the sample crop when collecting the sample crop phenotype datum and the type of the sample crop phenotype sensor; and
determining the second matching degree as an independent variable, determining the fourth weight score corresponding to the sample crop phenotype datum as a dependent variable, and calculating the fourth weight score corresponding to the sample crop phenotype datum based on the second matching degree and the positive correlation function.

8. The crop phenotype data fusion method according to claim 7, wherein the calculating the weight value corresponding to the sample crop phenotype datum based on the first weight score, the second weight score, the third weight score and the fourth weight score corresponding to the sample crop phenotype datum, comprises:
acquiring a time consistency evaluation value of the sample crop phenotype datum;
calculating a product of the first weight score, the second weight score, the third weight score and the fourth weight score of the sample crop phenotype datum as an intermediate result; and
calculating a quotient of the intermediate result divided by the time consistency evaluation value of the sample crop phenotype datum as the weight value corresponding to the sample crop phenotype datum.

9. The crop phenotype data fusion method according to claim 6, wherein the performing the data fusion on all first to-be-fused crop phenotype data after the initial alignment based on the weight values corresponding to all first to-be-fused crop phenotype data, to acquire the first fused data, comprises:
performing data fusion on the first to-be-fused crop phenotype data after initial alignment using an iterative closest point algorithm based on the weight values corresponding to the first to-be-fused crop phenotype data, to acquire the first fused data;
wherein the performing the data fusion on the second to-be-fused crop phenotype data after the initial alignment and the first fused data, to obtain the fused data, wherein the second to-be-fused crop phenotype data is the crop phenotype data except the first to-be-fused crop phenotype data in the plurality of to-be-fused crop phenotype data, comprises:
extracting features of the second to-be-fused crop phenotype data after initial alignment, to acquire feature information corresponding to the second to-be-fused crop phenotype data after initial alignment; and
mapping the feature information corresponding to the second to-be-fused crop phenotype data after initial alignment into the first fused data, to obtain the fused data.

10. A crop phenotype data fusion apparatus, comprising:
a first data acquisition module, wherein the first data acquisition module is configured to acquire a plurality of to-be-fused crop phenotype data, wherein the plurality of to-be-fused crop phenotype data comprises one or more of crop phenotype data of a target crop and crop phenotype data of the target crop in a plurality of growth stages, collected by different types of crop phenotype sensors;
a second data acquisition module, wherein the second data acquisition module is configured to acquire intrinsic and extrinsic parameter data of the crop phenotype sensors when collecting the plurality of to-be-fused crop phenotype data, as well as target data corresponding to first to-be-fused crop phenotype data, wherein the first to-be-fused crop phenotype data is three-dimensional data from the plurality of to-be-fused crop phenotype data, the target data comprises environmental data when collecting the crop phenotype data, relative position information between the crop phenotype sensors that collect the crop phenotype data and a crop, and target parameter values of the crop phenotype data, and the target parameter values comprise signal-to-noise ratios and/or feature entropies;
a dynamic weight determining module, wherein the dynamic weight determining module is configured to input all the target data corresponding to the first to-be-fused crop phenotype data into a weight adjustment model, and acquire a weight value corresponding to each first to-be-fused crop phenotype datum output by the weight adjustment model, wherein the weight adjustment model is obtained by training based on a target datum corresponding to each sample crop phenotype datum in a sample data set and a weight value corresponding to each sample crop phenotype datum, and sample crop phenotype data comprises crop phenotype data of a sample crop collected by different types of crop phenotype sensors and crop phenotype data of the sample crop in the plurality of growth stages;
a multi-source data fusion module, wherein the multi-source data fusion module is configured to perform data fusion on the plurality of to-be-fused crop phenotype data based on a weight value corresponding to each first to-be-fused crop phenotype datum and the intrinsic and extrinsic parameter data of the crop phenotype sensors that collect the plurality of to-be-fused crop phenotype data, to obtain fused data corresponding to the plurality of to-be-fused crop phenotype data; and
a characteristic estimation module, wherein the characteristic estimation module is configured to receive fused data of the target crop to output a characteristic indicator of the target crop, wherein the characteristic estimation module is obtained by training a neural network model based on sample fused data and a corresponding characteristic indicator.

11. An electronic device, comprising a memory, a processor, and a computer program stored in the memory and operable on the processor, wherein the processor, when executing the computer program, implements the crop phenotype data fusion method according to claim 1.

12. The electronic device according to claim 11, wherein the crop phenotype sensors comprise one or more of a laser radar sensor, a depth image sensor, a multispectral image sensor, a visible light image sensor, and an infrared thermal imaging sensor, wherein the laser radar sensor and the depth image sensor are configured to collect the first to-be-fused crop phenotype data which comprises three-dimensional imaging information, and the multispectral image sensor, the visible light image sensor, and the infrared thermal imaging sensor are configured to collect second to-be-fused crop phenotype data which comprises two-dimensional imaging information, wherein the second to-be-fused crop phenotype data is crop phenotype data except the first to-be-fused crop phenotype data in the plurality of to-be-fused crop phenotype data; and
wherein the fused data comprises environmental information of the target crop, spatiotemporal information, and one or more of the two-dimensional imaging information and the three-dimensional imaging information of the target crop.

13. The electronic device according to claim 11, wherein the crop phenotype sensors comprise a multispectral image sensor, and the fused data comprises two-dimensional imaging information, environmental information that comprises air temperature and soil moisture, and spatiotemporal information, and
wherein based on the fused data, the trained estimation model outputs a water stress risk index (WSI), and wherein the crop phenotype data fusion method further comprises: when the WSI is higher than a predetermined threshold, sending a signal to an existing irrigation system to instruct the existing irrigation system performing irrigation.

14. The electronic device according to claim 11, wherein the crop phenotype sensors comprise an infrared thermal imaging sensor and a visible light image sensor, and the fused data comprises two-dimensional imaging information that comprises RGB imaging and thermal imaging data, environmental information that comprises air temperature and soil moisture, and spatiotemporal information, and
wherein based on the fused data, the trained estimation model outputs a disease risk index (DRI), and wherein the crop phenotype data fusion method further comprises: when the DRI is higher than a predetermined threshold, sending a signal to an existing aerial spraying system to instruct the existing aerial spraying system performing spraying.

15. A non-transient computer-readable storage medium on which a computer program is stored, wherein the computer program, when executed by a processor, implements the crop phenotype data fusion method according to claim 1.

16. The non-transient computer-readable storage medium according to claim 15, wherein the crop phenotype sensors comprise one or more of a laser radar sensor, a depth image sensor, a multispectral image sensor, a visible light image sensor, and an infrared thermal imaging sensor, wherein the laser radar sensor and the depth image sensor are configured to collect the first to-be-fused crop phenotype data which comprises three-dimensional imaging information, and the multispectral image sensor, the visible light image sensor, and the infrared thermal imaging sensor are configured to collect second to-be-fused crop phenotype data which comprises two-dimensional imaging information, wherein the second to-be-fused crop phenotype data is crop phenotype data except the first to-be-fused crop phenotype data in the plurality of to-be-fused crop phenotype data; and
wherein the fused data comprises environmental information of the target crop, spatiotemporal information, and one or more of the two-dimensional imaging information and the three-dimensional imaging information of the target crop.

17. The non-transient computer-readable storage medium according to claim 15, wherein the crop phenotype sensors comprise a multispectral image sensor, and the fused data comprises two-dimensional imaging information, environmental information that comprises air temperature and soil moisture, and spatiotemporal information, and
wherein based on the fused data, the trained estimation model outputs a water stress risk index (WSI), and wherein the crop phenotype data fusion method further comprises: when the WSI is higher than a predetermined threshold, sending a signal to an existing irrigation system to instruct the existing irrigation system performing irrigation.

18. The non-transient computer-readable storage medium according to claim 15, wherein the crop phenotype sensors comprise an infrared thermal imaging sensor and a visible light image sensor, and the fused data comprises two-dimensional imaging information that comprises RGB imaging data and thermal imaging data, environmental information that comprises air temperature and soil moisture, and spatiotemporal information, and
wherein based on the fused data, the trained estimation model outputs a disease risk index (DRI), and wherein the crop phenotype data fusion method further comprises: when the DRI is higher than a predetermined threshold, sending a signal to an existing aerial spraying system to instruct the existing aerial spraying system performing spraying.
